(19) United States
(12) Patent Application Publication
(10) Pub. No.: US 2026/0278666 A1
(43) Pub. Date: Sep. 17, 2026

(54) PRODUCT OR SERVICE TRANSACTIONS USING AN EMBEDDED WIDGET

(71) Applicant: ALLSTATE INSURANCE COMPANY, NORTHBROOK, IL (US)

(72) Inventors: Michael S. Watson, Delaware, OH (US); Megan McNiven, Chicago, IL (US); Brent Sterling, Kent, OH (US); Dustin Jansen, Buffalo Grove, IL (US); Manish Muzumdar, Palo Alto, CA (US); Sean Beavers, Winamac, IN (US)

(21) Appl. No.: 19/563,267

(22) Filed: Mar. 11, 2026

Related U.S. Application Data
(60) Provisional application No. 63/770,496, filed on Mar. 12, 2025.

(51) Int. Cl. G06Q 30/0601; G06F 16/958; G06Q 20/32

(52) U.S. Cl. CPC G06Q 30/0641; G06F 16/958; G06Q 20/325

(57) ABSTRACT

Aspects of the disclosure relate to computer systems and methods to complete a product or service transaction journey using an embedded widget on a website. In some embodiments, a widget code portion may include one or more lines of code that may be embedded into an entity website. The embedded widget may load as part of the entity website by activation of a web browser. The embedded widget may generate one or more graphical interfaces for receiving input and/or interaction from a consumer. The embedded widget may connect to any number of services and/or application programming interfaces to complete a product or service transaction journey on the entity website. The embedded widget allows the consumer to remain on the entity website to complete the product or service transaction journey without being redirected to a website different than the entity website.

### CROSS-REFERENCE TO RELATED APPLICATIONS

This claims priority to U.S. Provisional Patent Application No. 63/770,496, filed on Mar. 12, 2025, the entire contents of which are incorporated by reference herein.

### FIELD

This invention generally relates to product or service transactions using a widget embedded in a website.

### BACKGROUND

Consumers select and purchase products or services from websites over the Internet. The consumers may input information and/or interact with websites to select and purchase various products or services. In some cases, the websites may include embedded links that redirect consumers to separate websites to complete product or service transactions (e.g., payments, purchase other similar products or services). However, being redirected to one or more separate websites different than original website may result in a negative user experience. Further, it may be undesirable for the consumer to have multiple websites or browsing sessions open to complete a transaction of products or services.

### SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

The present disclosure provides, in one aspect, a method that includes receiving, by a vendor system, a widget code portion, communicating the widget code portion to an entity system via a network connection between the entity system and the vendor system, the entity system including an entity website, and embedding the widget code portion in the entity website. The method includes generating, based on the widget code portion and activation of a web browser, an embedded widget as part of the entity website. The embedded widget is configured to generate one or more graphical interfaces for receiving input data from a consumer, wherein the one or more graphical interfaces include one or more data field entries configured to receive information associated with the consumer and a vendor item, establish, based on the received input data, a connection with the vendor system, wherein the establishing of the connection with the vendor system includes connecting to a service executing on the vendor system, based on a determination, by the service, that the vendor item is available and the received input data, connect to an application programming interface executing on the vendor system, and execute the application programming interface to determine vendor item information describing the vendor item. The embedded widget is further configured to generate, based on the vendor item information, one or more additional graphical interfaces for displaying the vendor item information, wherein the one or more additional graphical interfaces include one or more controls selectable by the consumer to modify the vendor item information, and in response to a consumer selection by the one or more controls, generate an additional graphical interface of the one or more additional graphical interfaces for completing a transaction of the vendor item on the entity website without the consumer being redirected to a website different than the entity website.

The present disclosure provides, in another aspect, a system that includes a vendor system including one or move vendor servers, the vendor system configured to generate a widget code portion, communicate the widget code portion to an entity system including one or more entity servers via a network connection between the vendor system and the entity system, the entity system including an entity website hosted on the one or more entity servers, wherein the widget code portion is embedded in the entity website. The system includes a computing device associated with a consumer, the computing device including at least one processor, a communication interface communicatively coupled to the at least one processor, a web browser, and memory storing computer-readable instructions that, when executed by the at least one processor, cause the computing device to generate, by activation of the web browser, an embedded widget as part of the entity website. The embedded widget is configured to generate one or more graphical interfaces for receiving input data from a consumer, wherein the one or more graphical interfaces include one or more data field entries configured to receive information associated with the consumer and a vendor item establish, based on the received input data, a connection with the vendor system, wherein the establishing of the connection with the vendor system includes connecting to a service executing on the vendor system, based on a determination, by the service, that the vendor item is available and the received input data, connect to an application programming interface executing on the vendor system, and execute the application programming interface to determine vendor item information describing the vendor item. The embedded widget is further configured to generate, based on the vendor item information, one or more additional graphical interfaces for displaying the vendor item information, wherein the one or more additional graphical interfaces include one or more controls selectable by the consumer to modify the vendor item information, and in response to a consumer selection by the one or more controls, generate an additional graphical interface of the one or more additional graphical interfaces for completing a transaction of the vendor item on the entity website without the consumer being redirected to a website different than the entity website.

The present disclosure products, in another aspect, a system that includes a vendor system including one or move vendor servers, the vendor system configured to generate a widget code portion, communicate the widget code portion to an entity system including one or more entity servers via a network connection between the vendor system and the entity system, the entity system including an entity website hosted on the one or more entity servers, wherein the widget code portion is embedded in the entity website. The system includes a computing device associated with a consumer, the computing device including at least one processor, a communication interface communicatively coupled to the at least one processor, a web browser, and memory storing computer-readable instructions that, when executed by the at least one processor, cause the computing device to generate, by activation of the web browser, an embedded widget as part of the entity website. The embedded widget is configured to generate one or more first graphical interfaces for receiving input data from a consumer, wherein the one or more first graphical interfaces include one or more data field entries configured to receive information associated with the consumer and a vendor item, establish, based on the received input data a connection with the vendor system, wherein the establishing of the connection with the vendor system includes connecting to a service executing on the vendor system, based on a determination, by the service, that the vendor item is available and the received input data, connect to an application programming interface executing on the vendor system, and execute the application programming interface to determine vendor item information describing the vendor item. The embedded widget is further configured to generate, based on the vendor item information, one or more second graphical interfaces for displaying the vendor item information, wherein the one or more second graphical interfaces include one or more controls selectable by the consumer to modify the vendor item information, and in response to a consumer selection by the one or more controls, generate one or more third graphical interfaces for completing a transaction of the vendor item on the entity website without the consumer being redirected to a website different than the entity website.

The arrangements described can also include other additional elements, steps, computer-executable instructions, or computer-readable data structures. In this regard, other embodiments are disclosed and claimed herein as well. The details of these and other embodiments of the present invention are set forth in the accompanying drawings and the description below. Other features and advantages of the invention will be apparent from the description, drawings, and claims.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals.

FIG. 1 illustrates a computing environment for an item transaction system according to one or more embodiments.

FIG. 2 illustrates a data flow diagram showing the transfer of data between one or more computing systems of a product or service transaction system according to one or more embodiments.

FIG. 3 illustrates an entity website including an embedded widget according to one or more embodiments.

FIGS. 4A-4D illustrates one or more graphical interfaces of the embedded widget of FIG. 3 showing a portion of an item transaction according to one or more embodiments.

FIG. 5 illustrates an item transaction system including a computing device, an entity system, and a vendor system according to one or more embodiments.

FIG. 6 is a flow chart illustrating a method for completing an item transaction using an embedded widget according to one or more embodiments.

FIG. 7 is a flow chart illustrating a method for completing an item transaction using an embedded widget according to one or more embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Described herein is an item transaction system for completing a product or service transaction journey for a consumer using an embedded widget. A vendor may offer vendor products or services through an entity’s website (e.g., company or enterprise) via the embedded widget. The vendor may be a different enterprise than the entity. The vendor may have a vendor system including one or more services, one or more software applications, one or more on-demand software applications, and/or one or more application programming interfaces (APIs). The services and the application programming interfaces of the vendor system may be used to complete one or more transactions of vendor products or services. The embedded widget may communicate with the services and/or application programming interfaces of the vendor system to complete transactions of vendor products or services on the entity website.

The embedded widget may improve the product or service transaction process on websites over the Internet. In some embodiments, the embedded widget may improve the purchasing experience of one or more insurance products. In some embodiments, the embedded widget may allow a consumer to browse for one or more insurance quotes, receive one or more insurance quotes, receive one or more updated insurance quotes, and bind to one or more insurance quotes all within the embedded widget without having to be redirected to external websites or a website that hosts the insurance services. The embedded widget may hide the complexity of multiple communications between the services and/or application programming interfaces of the vendor system and the entity website. The embedded widget allows a consumer to remain on the entity website without being redirected to a separate website to complete vendor product or service transactions. The embedded widget allows the consumer to continue browsing on the entity website for entity products or services while having the option to select and purchase one or more vendor products or services. The embedded widget allows for an improved user experience for completing product or service transactions on websites over the Internet.

### Computing Systems and Operating Environment

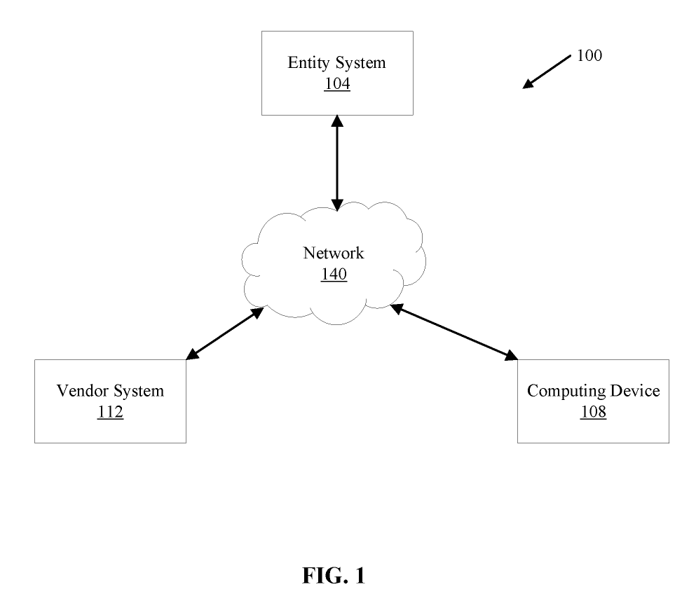

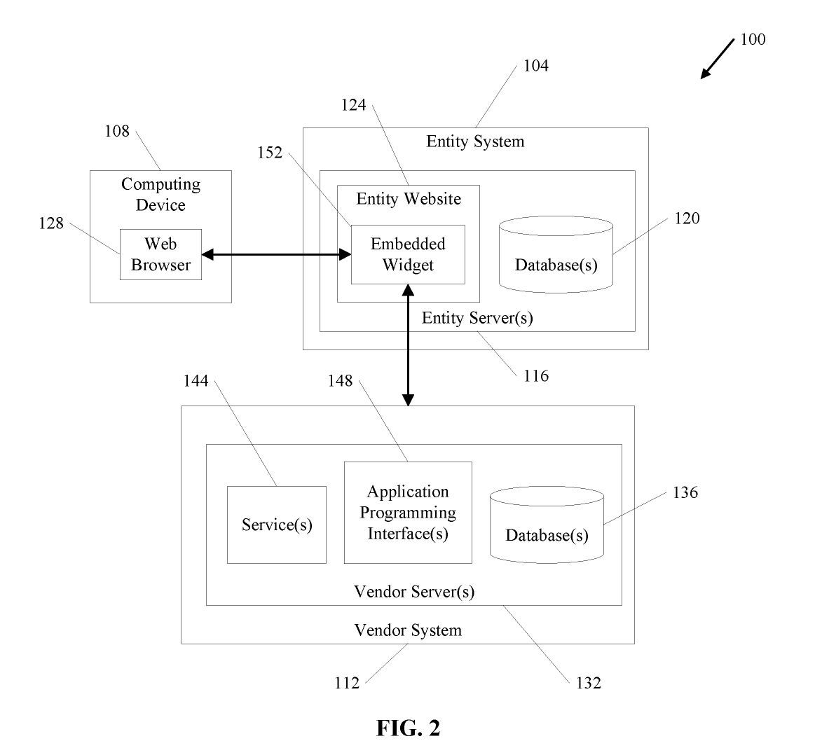

FIGS. 1 and 2 illustrate a computing environment for a product or service transaction system 100 (hereafter “item transaction system 100”) for completing transactions for products or services (hereafter “items”) according to one or more embodiments. Referring to FIG. 1, the item transaction system 100 may include one or more computing systems. For example, the item transaction system 100 may include an entity system 104, a computing device 108, and a vendor system 112.

As shown in FIGS. 1 and 2, the entity system 104 may include one or more computing devices or computer devices (e.g., servers, server blades, web servers, cloud-based servers, and/or other devices), and/or other computer components (e.g., processors, memories, communication interfaces). In some embodiments, the entity system 104 may include one or more entity servers 116. The one or more entity servers 116 may be co-located and/or geographically distributed. The entity system 100 may be configured to store and provide information associated with one or more entity products or services (generally referred to as “entity items”). The entity system 104 may store or be connected to one or more entity databases 120 that store various types of data or information that may be associated with entity items, consumers, other data, other information, and/or any combination thereof.

With reference to FIG. 2, the entity system 104 may include an entity website 124. The entity website 124 may include a plurality of entity web pages. The entity website 124 and/or the plurality of entity web pages may be hosted on the one or more entity servers 116. The entity website 124 including the plurality of entity webpages may be connected to the entity databases 120 that store various types of data that may be associated with entity items and consumers. The entity website 124 may include one or more Hypertext Markup Language (HTML) based web documents.

The entity system 104 may be owned or controlled by various enterprises or companies. For example, the entity system 104 may include a website of an enterprise that offers for sale one or more entity items. Examples of entity items may include an insurance verification process service, a rental property management service, a rental payment service, a home, a vehicle, a home loan payment service, a vehicle loan payment service, a document management service, other products, other services, other items, and/or any combination thereof. As described in more detail below, the entity system 104 may offer for sale one or more entity items and the vendor system 112 may offer one or more vendor items, where the vendor items are different than the entity items.

As shown in FIGS. 1 and 2, the computing device 108 may include one or more computing devices or computer devices (e.g., smartphone, tablet, laptop computers, desktop computers, other personal computing devices, server, server, blades, or the like), and/or other computer components (e.g., processors, memories, communication interfaces). The computing device 108 may include one or more graphical user interfaces configured to receive input from a consumer. The computing device 108 may include a web browser 128. The web browser 128 may be configured to load websites and webpages by various enterprises or companies. For example, the web browser 128 may load the entity website 124 including the plurality of entity webpages hosted on the entity system 104. The web browser 128 may allow a user to select and purchase entity items using the web browser 128 of the computing device 108. In some embodiments, the web browser 128 may load a website hosted by the vendor system 112 to select and purchase vendor items offered by the vendor system 112.

As described in greater detailed below and as shown in FIGS. 1 and 2, the vendor system 112 may include one or more computing devices or computer devices (e.g., servers, server blades, web servers, cloud-based servers, and/or other devices), and/or other computer components (e.g., processors, memories, communication interfaces). In some embodiments, the vendor system 112 may include one or more vendor servers 132. The one or more vendor servers 132 may be co-located and/or geographically distributed. The one or more vendor servers 132 may be different than the one or more entity servers 116 (e.g., separate, located in different geographical locations). The vendor system 112 may be configured to store and provide information associated with one or more vendor products or services (generally referred to as “vendor items”). In some embodiments, the vendor items may include insurance products such as auto, home, or renter’s insurance policies.

As shown in FIG. 2, the vendor system 100 may store or be connected to one or more vendor databases 136 that store various types of data or information that may be associated with vendor items, consumers, region specific regulations associated with vendor items, state specific regulations associated with vendor items, other products, other services, other vendor items, other data, other information, and/or any combination thereof. In some embodiments, the vendor system 112 may include data or information associated with auto insurance policies, renter insurance policies, home insurance policies, and/or any combination thereof. The vendor system 112 may be owned or controlled by various enterprises or companies. In some embodiments, the vendor system 112 may be owned or controlled by an insurance company that provides insurance (e.g., automotive insurance, home insurance, renter insurance), or another company that manages and maintains the vendor system 112 on the behalf of (or for providing a service to) an insurance company.

With reference to FIG. 1, the computing environment of the item transaction system 100 may also include one or more networks, which may interconnect the computing systems of the item transaction system 100 including the entity system 104, the computing device 108, and the vendor system 112. The computing environment may further interconnect one or more other systems, public networks, sub-networks, and/or the like. For example, the computing environment may include a network 140. The network 140 may be a wired or wireless network 140, which may interconnect the entity system 104, the computing device 108, and the vendor system 112. Further, as shown in FIG. 2, data may transfer or flow between the entity system 104, the computing device 108, and the vendor system 112.

In one or more arrangements, the entity system 104, the computing device 108, the vendor system 112, and/or other systems in the computing environment may be any type of computing device capable of receiving a user interface, receiving input via the user interface, and/or communicating the received input to one or more other computing devices. For example, the systems included in the computer environment may be and/or include server computers, desktop computers, laptop computers, mobile computers, tablet computers, cell phones, smart phones, network computing devices configured to communicate over a network, or the like that may include one or more processors, memories, communication interfaces, databases, storage devices, and/or other components. As noted above, and as described in greater detail below, any and/or all of the entity system 104, the computing device 108, and the vendor system 112 may be special-purpose computer devices configure to perform specific functions.

Referring to FIG. 2, the vendor system 112 may include one or more services 144 (hereafter “services 144”) and/or one or more application programming interfaces 148 (hereafter “APIs 148”). The services 144 and/or the APIs 148 may run and execute on the vendor system 112. More specifically, the services 144 and/or the APIs 148 may run and execute on the one or more vendor servers 132. In other embodiments, the vendor system 112 may be in communication with one or more other systems that host other services and/or APIs.

The services 144 may include various services for vendor items and consumers. The one or more services may also be referred to as one or more software applications, or one or more on-demand software applications. The services 114 may not be hosted on the entity system 104. In other words, the services 114 may be hosted only on the vendor system 112. The services 144 may include a vendor item service, an auto insurance service, a home insurance service, a renter insurance service, a vendor item determination service, a regulation compliance service associated with vendor items, a region regulation compliance service, a state regulation compliance service, a payment service, an insurance quoting service, an insurance binding service, an insurance policy service, other services, and/or any combination thereof. For example, the vendor system 112 may include a vendor item determination service that determines whether one or more vendor items are available to a consumer based on the received consumer input (e.g., consumer information, inquiry in vendor item). For example, the vendor item determination service may compare the received consumer input to one or more regulations to ensure the one or more vendor items may be offered for purchase in the region. For example, the one or more regulations may be based on a region, state, country, etc., and/or a geolocation of a consumer. For example, the vendor system 112 may include one or more unwriting services to evaluate a potential consumer for one or more insurance products. The one or more unwriting services may include algorithms and/or models to analyze data associated with a consumer or a consumer’s properties (e.g., home, auto, renter) to assess the risk of insuring a consumer. For example, the vendor system 112 may include one or more insurance quoting services that generate one or more insurance quotes for a consumer based on input data. For example, the vendor system 112 may, after receiving subsequent input data from a consumer, generate one or more updated insurance quotes for the consumer via one or more insurance quoting services. For example, after a consumer is satisfied with an insurance coverage of an insurance quote, the vendor system 112 may include one or more insurance binding services to allow the consumer to purchase one or more insurance products.

Further, for example, the vendor system 112 may include a payment service that completes a payment transaction for one or more vendor items. The payment service may include a banking account, a debit card, or a credit card payment method to complete a payment transaction for the vendor items. The payment service may include one or more communications to a financial institution, or another company that manages and maintains financial services on the behalf (or providing a service to) a financial institution. For example, the vendor system 112 may include an encryption service that encrypts information entered by a consumer during a vendor item transaction. In some embodiments, the encryption service may include a secure transfer protocol such as Hypertext Transfer Protocol Secure (“HTTPS”). In some embodiments, the encryption service may execute in combination with other services 144 to ensure a consumer’s information is protected during a vendor item transaction process.

In some embodiments, the services 144 may include custom built services that supplement the vendor item transaction process. For example, the services 144 may include a service engine that executes one or more instructions to determine vendor item information describing the vendor item, and a service database that stores and provides information associated with the vendor items. The service engine may be in communication with the service database. The service engine and service database may run and execute on the vendor system 144. In other embodiments, the services 144 may include custom built software applications or on-demand software applications that supplement and/or support the vendor item transactions process. In some embodiments, the software applications and/or on-demand software applications may be built for specific products or services offered by the vendor system 112.

The APIs 148 may include various APIs for vendor items and consumers. The APIs 148 may include one or more microservices for vendor items or consumers. The APIs 148 may not be hosted on the entity system 104. In other words, the APIs 148 may be hosted only on the vendor system 112. In some embodiments, the microservice may be in communication with a database that is configured to store and provide data to the microservice. For example, the APIs 148 may include an API for a vendor item, an auto insurance policy, a home insurance policy, a renter’s insurance policy, and/or any combination thereof. In some embodiments, the APIs 148 may include an API for an enterprise or company. For example, the APIs 148 may include an API for an insurance company offering one or more insurance products.

With continued referenced to FIG. 2, the services 144 may be in communication with the APIs 148. In some embodiments, the services 144 may communicate with the APIs 148 during a vendor item transaction. In other words, the outputs of the services 144 may be used as inputs for the APIs 148. Described in another way, the outputs of the APIs 148 may be used as inputs for the services 144. For example, data may transfer or flow between the services 144 and the APIs 148 during a vendor item transaction journey. As described in more detail below, the services 144 and/or the APIs 148 of the vendor system 112 may be in communication with the entity system 104. Data may transfer or flow between the services 144, the APIs 148, the vendor system 112, the entity system 104, the computing device 108, other computing systems in the item transaction system 100, and/or any combination thereof.

### Embedded Widget

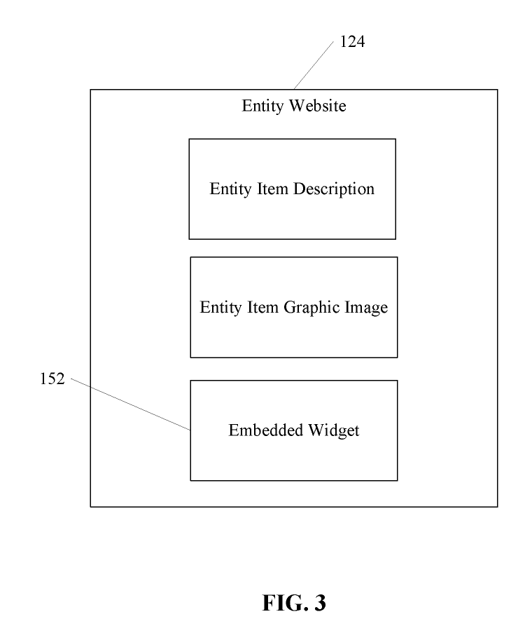

Referring to FIGS. 2 and 3, the item transaction system 100 may include an embedded widget 152. The embedded widget 152 may be embedded in the entity website 124 and/or one or more entity webpages. The embedded widget 152 may allow a consumer to remain on the entity website 124 to complete a vendor item transaction without being redirected to a separate website or a website hosted on a separate server. As described in more detail below, the embedded widget 152 may hide the complexity of executing multiple services 144 or APIs 148 that may be needed to complete a vendor item transaction journey on the entity website 124. The embedded widget 152 may improve the consumer experience of selecting and purchasing items on websites over the Internet. In one example, the embedded widget 152 may allow a consumer to complete the entire purchasing journey (e.g., quote, re-quote, bind, pay) of one or more insurance products (e.g., auto insurance policy, home insurance policy, renter’s insurance policy) all within the embedded widget 152.

The vendor system 112 or an enterprise that controls the vendor system 112 may communicate the embedded widget 152 to the entity system 104 or an enterprise that controls the entity system 104. In some embodiments, the vendor system 112 may communicate a widget code portion to the entity system 104. The widget code portion may include one or more lines of HTML and/or JavaScript code. The widget code portion may be incorporated into the entity website 124, one or more entity webpages, and/or other web documents of the entity system 104. For example, the widget code portion may be incorporated into HTML and/or JavaScript code of the entity website 124. For example, the embedded widget 152 may be a JavaScript Object Notation (“JSON”) object incorporated in the entity website 124.

When loaded by the web browser 128 of the computing device 108 (or other web browser in the computing environment), the widget code portion as part of the entity website 124 may generate the embedded widget 152. In some embodiments, the vendor system 112 may generate the widget code portion for incorporation in the entity website 124. In some embodiments, an enterprise that controls the vendor system 112 may generate the widget code portion for incorporation in the entity website 124. In some embodiments, when loaded by the web browser 128 of the computing device 108, the widget code portion may be in communication with a service that embeds the embedded widget 152 in the entity website 124 while establishing one or more connections to the vendor system 112.

With continued reference to FIGS. 2 and 3, the embedded widget 152 may establish a gateway. In some embodiments, the gateway may be a network gateway, an API gateway, and/or any combination thereof. The gateway may establish one or more connections between the entity system 104 and the vendor system 112. More specifically, the gateway may establish one or more connections from the entity website 124 to the services 144 and/or the APIs 148 of the vendor system 112. As described in more detail below, the establishment of the gateway allows the embedded widget 152 to connect and execute the services 144, the APIs 148, and/or any combination thereof to complete a vendor item transaction on the entity website 124.

In some embodiments, the gateway may abstract, hide, or conceal one or more connections between the entity website 124 and the vendor system 112. In other words, an enterprise of the entity system 104 does not have to establish the connections (e.g., write code or incorporate complex APIs) on the entity website 104 to the vendor system 112. The enterprise of the entity system 104 may incorporate the widget code portion in the entity website 124 with minimal effort (i.e., simple copy and paste of the widget code portion) to establish one or more connections to the vendor system 112. In some embodiments, from a perspective of a consumer, the transaction of a vendor item (or vendor item transaction journey) on the entity website 124 may appear to be processed only by entity website 124. A front end of the vendor item transaction (e.g., embedded widget 152) may occur on the entity website 124 while a back end of the vendor item transaction journey (e.g., execution of the services 144 and/or the APIs 148) may occur on the vendor system 112. Integrating the widget code portion in the entity website 124 to generate the embedded widget 152 may allow the enterprise of the entity system 104 to integrate more complicated functionality into the entity website 124 such as by using the APIs 148 and/or the services 144 for the vendor item transactions. The embedded widget 152 may improve the consumer experience by allowing the consumer to complete a vendor item transaction journey while browsing for entity items of the entity website 124, where the vendor items may be different than the entity items.

The embedded widget 152 may establish one or more connections with the services 144 and/or the APIs 148 in response to consumer input or interaction (e.g., input data) with the embedded widget 152. The received consumer input may transfer to the vendor system 112 for processing. Processing the received consumer input may include executing the services 144 and/or the APIs 148 on the vendor system 112. The output of the services 144 and/or APIs 148 may be returned to the embedded widget 152 for further review by the consumer. The receiving of consumer input via the embedded widget 152, and executing the services 144 and/or the APIs 148 on the vendor system 112 may occur any number of times during a vendor item transaction journey. In other words, receiving input data from a consumer, executing the services 144 and/or the APIs 148, returning the output of the services 144 and/or the APIs 148, receiving subsequent input data from the consumer may occur any number of times or over a period of time during a vendor item transaction journey.

For example, in response to receiving one or more inputs (e.g., input data) from the consumer, the embedded widget 152 may establish a first connection with a first service 144 executing on the vendor system 112. In some embodiments, the first service 144 may be a vendor item determination service that determines the availability of one or more vendor items to the consumer based on the received consumer input. For example, after executing of the first service 144, the embedded widget 152 may establish a second connection with an application programing interface 148 executing on the vendor system 112. In some embodiments, the application programming interface 148 may determine vendor item information describing a vendor item. In some embodiments, after executing the application programming interface 148, the embedded widget 152 may display the vendor item, the vendor item information, and/or one or more modification or update options for review by the consumer.

Further, after the embedded widget 152 receives additional input or interaction from the consumer, the embedded widget 152 may establish an additional connection with an additional service executing on the vendor system 112. In some embodiments, the additional service may be a payment processing service configured to complete a payment transaction of the vendor item. In other embodiments, the embedded widget 152 may establish any number of connections (e.g., first, second, third, fourth, fifth, etc. connections) with any number of services 144 (e.g., first, second, third, fourth, fifth, etc. services 144) and/or APIs 148 (e.g., first, second, third, fourth, fifth, etc. APIs 148) on the vendor system 112. The embedded widget 152 may establish any number of connections with any number of services 144 and/or APIs 148 during any point in the vendor item transaction journey on the entity website 124. As described in more detail below, the consumer may input information and/or interact with the embedded widget 152 via one or more graphical interfaces 156.

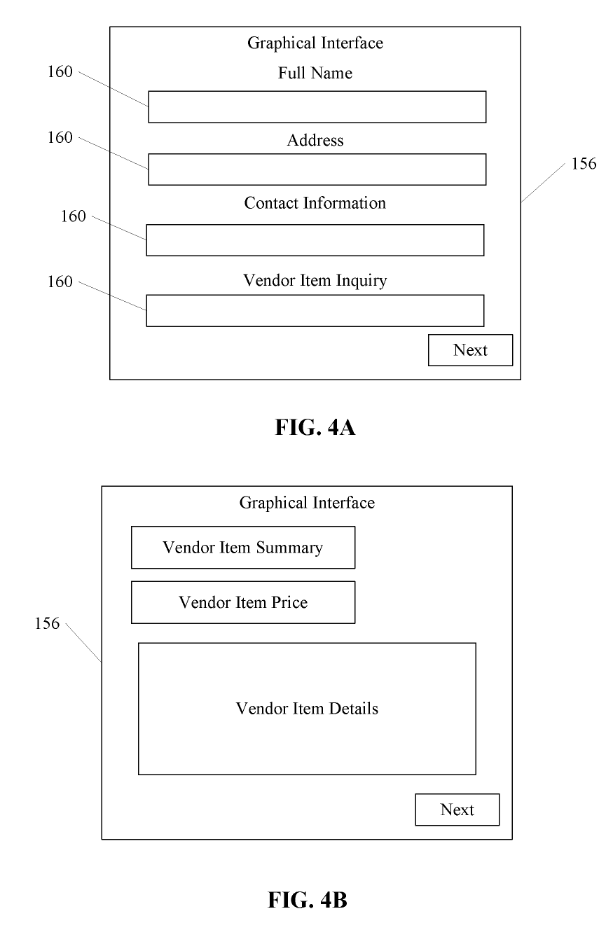

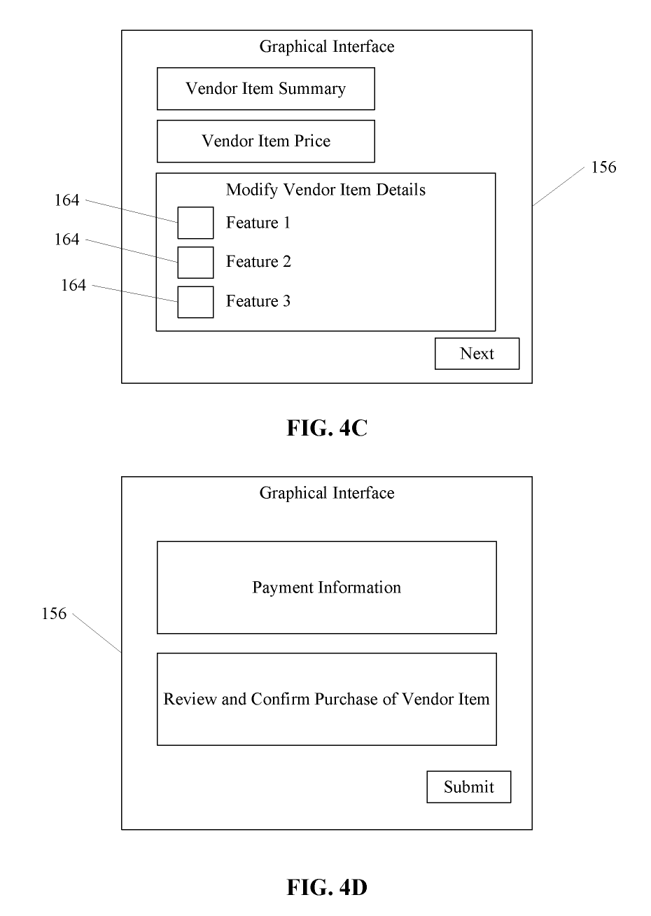

With reference to FIGS. 3 and 4A-4D, the embedded widget 152 may generate one or more graphical interfaces 156. The one or more graphical interfaces 156 may generate in response to activation by the web browser 128 of the computing device 108. Described in another way, the embedded widget 152 may be a window on one or more webpages of a website that hosts the embedded widget 152, where the window may be embedded in the one or more webpages of the website (e.g., entity website 124 of FIG. 2). The one or more graphical interfaces 156 may generate in response to consumer input and/or interaction with the embedded widget 152. The one or more graphical interfaces 156 may display one or more data field entries, one or more selectable or interactable controls (e.g., buttons, drop-down menus, switches, toggles, etc.) graphics, vendor items, information associated with vendor items, consumer information, etc.

The one or more graphical interfaces 156 may update or refresh based on the received input or interaction from the consumer. The one or more graphical interfaces 156 of the embedded widget 152 may refresh a portion of the entity website 124 in response to consumer input or interaction. In other words, the embedded widget 152 may dynamically refresh a portion the entity website in response to consumer input interaction. For example, the one or more graphical interfaces 156 may refresh in response to a consumer inputting values in one or more data field entries. For example, the one or more graphical interfaces 156 may refresh in response to a consumer interacting with the embedded widget (e.g., clicking buttons, scrolling, selecting, interacting with controls that operate the embedded widget 152). The remaining portions of the entity website 124 may remain static as the embedded widget 152 refreshes via the one or more graphical interfaces 156. The one or more graphical interfaces 156 remain in the entity website 124. In other words, the one or more graphical interfaces 156 of the embedded widget 152 may not be a separate pop out window or form. The one or more graphical interfaces 156 of the embedded widget 152 may retain the consumer to the entity website 124 while performing the vendor item transaction journey without redirecting the consumer to separate websites, forms, pop out windows, etc.

FIGS. 4A-4D illustrate examples of one or more graphical interfaces 156. The embedded widget 152 may generate other graphical interfaces 156 in other embodiments. For example, as shown in FIG. 4A, the embedded widget 152 may generate one or more first graphical interfaces 156 that display one or more data field entries 160. A consumer may input one or more values in the one or more data field entries 160. The consumer may input information and/or inquire about a vendor item via the one or more graphical interfaces 156. The embedded widget 152 may collect information associated with the consumer and the vendor item that the consumer may be interested in. In some embodiments, the first graphical interfaces 156 may include a series of graphical interfaces 156 that may collect identifying information about a consumer and information associated with a vendor item. For example, the first graphical interfaces 156 may receive consumer input data associated with an insurance product such as an auto, a home, or a renter’s insurance policy.

For example, in response to the received consumer input and as shown in FIGS. 4B and 4C, the embedded widget 152 may generate one or more second graphical interfaces 156 (or one or more additional graphical interfaces 156) that display the vendor item information describing the vendor item, details of the vendor item, and one or more controls 164 for modifying the vendor item. In some embodiments, the second graphical interfaces 156 may include a series of graphical interfaces 156 that allow the consumer to select, modify, or update information associated with the vendor item. The consumer may select, modify, or update information associated with the vendor item via the one or more controls 164. For example, the vendor item may be an insurance product such as an auto, a home, or a renter’s insurance policy. For example, the second graphical interfaces 156 may allow the consumer to select, modify, or update information associated with an insurance product (e.g., coverage details, quote, price, number of policy holders, etc.).

For example, in response to the received additional consumer input and as shown in FIG. 4D, the embedded widget 152 may generate one or more third graphical interfaces 156 (or one or more additional graphical interfaces 156) to complete a transaction for the vendor item. In some embodiments, the third graphical interfaces 156 may include a series of graphical interfaces 156 that display one or more steps of a payment transaction for the vendor item. For example, the third graphical interfaces 156 may allow the consumer to purchase the vendor item via a payment processing service. For example, the third graphical interfaces 156 may allow the consumer to purchase an insurance product. In other embodiments, the embedded widget 152 may generate additional graphical interfaces 156 as needed to complete the vendor item transaction on the entity website 124. For example, the embedded widget 152 may generate first, second, third, fourth, fifth, etc. graphical interfaces 156 to complete the vendor item transaction on the entity website 124. Still, in other embodiments, the embedded widget 152 may generate any number of graphical interfaces 156 to allow a consumer to select and purchase a vendor item on the entity website 124. In other words, the embedded widget may generate any number of graphical interfaces 156 during a vendor item transaction journey.

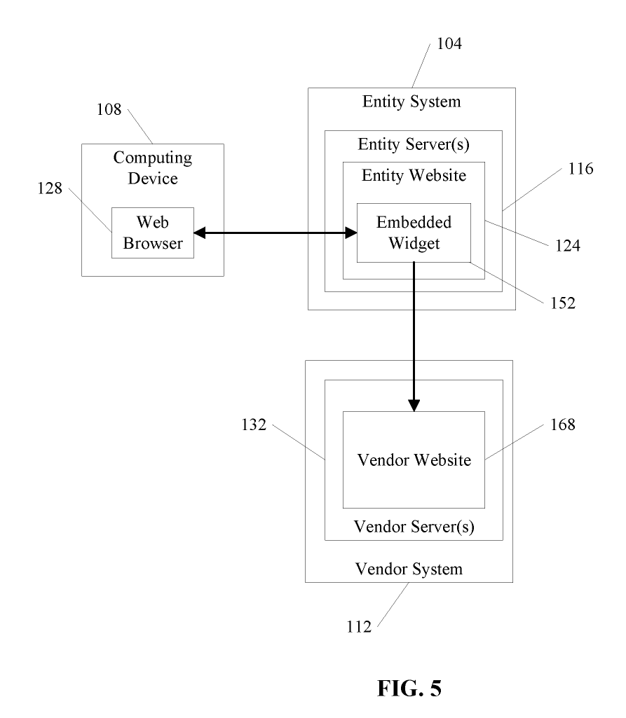

With reference to FIG. 5, in some embodiments, the embedded widget 152 may redirect the consumer to a separate or different website that may be hosted on a separate server than the entity website 124. The consumer may complete the vendor item transaction on the separate website. For example, the embedded widget 152 may redirect the consumer to a vendor website 168 to complete the vendor item transaction. The vendor website 168 may be hosted on the vendor system 112 or the vendor servers 132.

In some embodiments, the embedded widget 152 may redirect the consumer from the entity website 124 when an anomaly or deviation occurs during a vendor item transaction. The occurrence of the anomaly or deviation during the vendor item transaction may also be referred to as a bump out event, or an event that redirects the consumer away from the entity website 124. For example, the received consumer input (or information, or input data) may not conform to one or more requirements (or regulations) of a service (e.g., services 144 of FIG. 2) running on the vendor system 112. For example, an anomaly or deviation may occur when a vendor item determination service determines one or more vendor items may not be available to the consumer. For example, the one or more vendor items may not be available due to a type of entity website 124 and a geolocation of the consumer. For example, the type of entity website 124 may refer to a licensed or unlicensed status to offer one or more vendor items. For example, the entity website 124 be licensed or approved to offer one or more vendor items for various regions, states, or geolocations. For example, the entity website 124 may be unlicensed or not approved to offer one or more vendor items for various regions, states, or geolocations. In some embodiments, an anomaly or deviation may occur when the received consumer input data indicates a region, a state, or a geolocation the entity website 124 may not be approved or unlicensed to offer the one or more vendor items. For example, when the entity website 124 (or entity system 104) may be unlicensed or not approved to offer one or more vendor items, the embedded widget 152 may redirect a consumer to a separate website or website hosted on the vendor system 112 to complete the vendor item transaction journey to ensure compliance with rules and regulations that may be associated with a region, state, or geolocation.

With continued reference to FIG. 5, when an anomaly or deviation occurs, the embedded widget 152 may redirect the consumer to the vendor website 168 hosted on the vendor system 112. Redirecting the consumer to the vendor website 168 may include an encrypted service or a secure transfer protocol such as Hypertext Transfer Protocol Secure (“HTTPS”) to allow the consumer to complete the vendor item transaction. The consumer may complete the vendor item transaction on the vendor website 168. The vendor website 168 may be communication with the services 144 and/or APIs 148 during the vendor item transaction.

In some embodiments, the embedded widget 152 may prepopulate data in the one or more graphical interfaces 156 during activation of the web browser 128. More specifically, the embedded widget 152 may prepopulate data in one or more data field entries 160 of the one or more graphical interfaces 156 (FIG. 4A). For example, the entity system 104 may include data associated with a consumer (e.g., identifying information, account information, previous purchase of entity item, payment information, data associated with the consumer etc.). The embedded widget 152 may receive or include instructions to receive the data associated with the consumer stored on the entity system 104. The pre-population of consumer data may happen in real-time or instantaneously as the embedded widget 152 is loaded as part of the entity website 124. In some embodiments, the one or more graphical interfaces 156 of the embedded widget 152 may include prepopulated data at any point during a vendor item transaction (e.g., initial load by the web browser 128, one or more refreshes of the graphical interfaces 156). In some embodiments, the widget code portion may include one or more additional lines of code (e.g., HTML or JavaScript) to incorporate a pre population or prefill feature in the embedded widget 152.

### Product or Service Transactions using an Embedded Widget

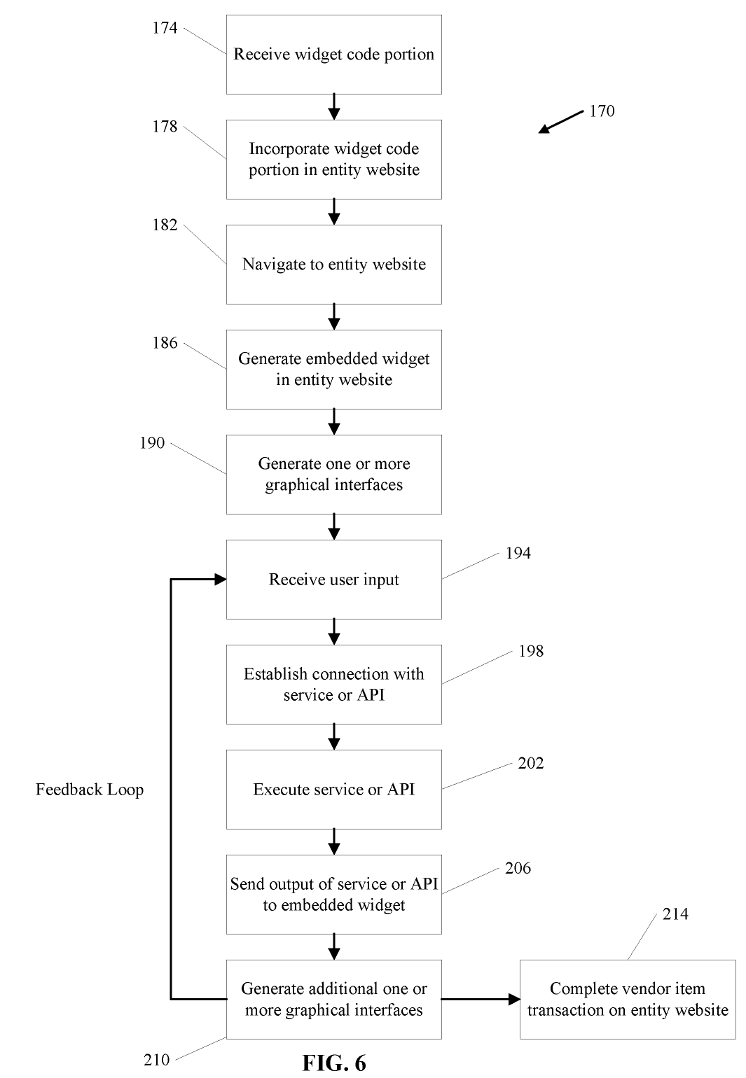

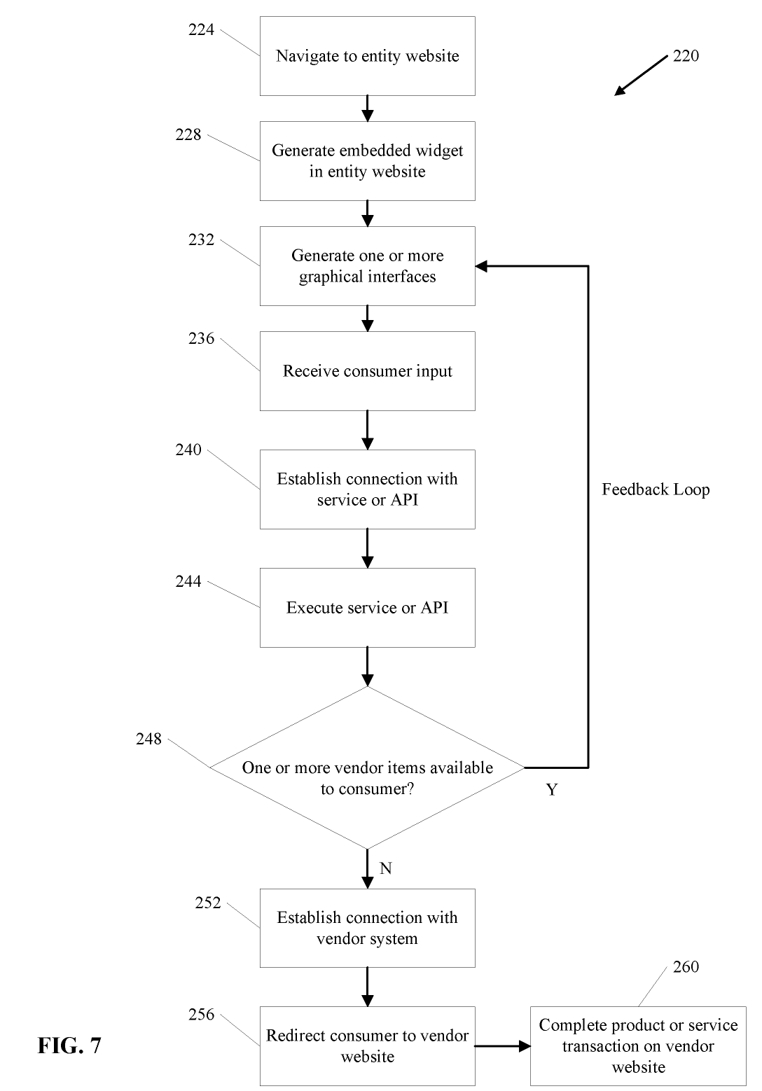

FIG. 6 is a flow chart illustrating a method 170 (or process 170) for completing item transactions or an item transaction journey on websites over the Internet according to one or more embodiments. Some or all the steps of method 170 may be performed using one or more computing devices and/or combination thereof described in this disclosure. In a variety of embodiments, some or all of the steps described below may be combined and/or divided into sub-step as appropriate.

Referring to FIG. 6, at step 174, an enterprise of the entity system 104 may receive a widget code portion from an enterprise of the vendor system 112. At step 178, the enterprise of the entity system 104 may incorporate the widget code portion in the entity website 124. At step 182, a consumer may navigate to the entity website 124 using the web browser 128 of the computing device 108. At step 186, in response to activation by the web browser 128 of the computing device 108, the embedded widget 152 may load or generate as part of the entity website 124. In other words, the embedded widget 152 may load or generate as part of the entity website 124 in response to a consumer navigating one or more webpages of the entity website 124.

At step 190, as the entity website 124 loads, the embedded widget 152 may generate one or more graphical interfaces 156. In other words, the embedded widget 152 may generate one or more windows on the entity website 124, where the one or more windows may be embedded in one or more webpages of the entity website 124. At step 194, the consumer may interact with the embedded widget 152 or input information (e.g., input data) in the embedded widget 152 to complete a vendor item transaction or vendor item transaction journey on the entity website 124. In some embodiments, the one or more graphical interfaces 156 may include one or more data field entries 160 for receiving consumer input and inquiring about a vendor item (FIG. 4A). In some embodiments, the consumer input may include identifying information such as name and address, and the vendor item inquiry may be about an insurance product such as auto, home, or renter’s insurance policy. At step 198, after receiving the consumer input and the vendor item inquiry, the embedded widget 152 may establish a connection with the services 144 or the APIs 148 on the vendor system 112. For example, the embedded widget 152 may establish a connection with a service 144 executing on the vendor system 112.

At step 202, the vendor system 112 may execute the services 144 or APIs 148 based on the received consumer input and the vendor item inquiry. In some embodiments, the service 144 may include a vendor item determination service that may determine one or more vendor items available to the consumer based on the received consumer input and vendor item inquiry. For example, the vendor item determination service may determine whether the entity website 124 is approved to offer the vendor item based on a geolocation of the consumer, and rules and regulations associated with offering the vendor item in the geolocation.

At step 206, the vendor system 112 may send an output of the services 144 and/or APIs 148 executed at step 202 to the embedded widget 152. At step 210, in response to the output of the services 144 and/or APIs 148, the embedded widget 152 may generate additional graphical interfaces 156. The additional graphical interfaces 156 may receive additional consumer input and/or interactions from the consumer to complete a vendor item transaction on the entity website 124.

Based on the number of the services 144 and/or the APIs 148 that may be needed to complete the vendor item transaction or vendor item transaction journey, the item transaction system 100 may continue to operate and may repeat steps 194, 198, 202, 206, 210 as additional consumer input or interaction continues to be received (FIG. 6). For example, after the successful execution of the services 144 (e.g., the vendor item determination service determines whether the vendor item is available to the consumer), the embedded widget 152 may establish a connection with the APIs 148 on the vendor system 112. The APIs 148 may determine vendor item information describing the vendor item. For example, the APIs 148 may include an API for a vendor item such as an insurance product. In some embodiments, the insurance product may be an auto, home, or renter’s insurance policy. For example, the APIs 148 may determine the details of the insurance policy based on the received consumer input. For example, based on the received consumer input, the APIs 148 may determine insurance policy details such as an insurance quote and one or more insurance coverages. After the API 148 determines the vendor item information describing the vendor item, the vendor system 112 may send the output of the API to the embedded widget 152.

Further, after execution of services 144 and/or APIs 148, at step 210, the embedded widget 152 may display the vendor item information describing the vendor item via the one or more additional graphical interfaces 156. The embedded widget 152 may display one or more controls 164 for modifying the vendor item, and/or one or more data fields for receiving additional consumer input via the one or more additional graphical interfaces 156. For example, the embedded widget 152 may display the proposed insurance policy including the quote and coverage details. For example, the consumer may input additional information or interact with the data field entries 160 and/or controls 162 to modify, remove, add, etc. coverage details.

For example, after the consumer is satisfied with the insurance policy coverage and details, the embedded widget 152 may communicate with one or more binding services to allow the consumer to purchase the insurance policy. For example, after the consumer is satisfied with the insurance policy, the embedded widget 152 may establish a connection with a payment processing service. The payment processing service may execute on the vendor system 112 and return the output via one or more additional graphical interfaces 156. The consumer may complete the payment of the insurance policy via the one or more additional graphical interfaces 156. In other embodiments, the item transaction system 100 may execute one or more additional services 144 and/or APIs 148 to complete the vendor item transaction as described in this disclosure. Still, in other embodiments, the item transaction system 100 may perform vendor item transactions using the embedded widget 152 for other vendor items as described in this disclosure.

At step 214, the consumer may complete the vendor item transaction on the entity website 124. The embedded widget 152 may display one or more additional graphical interfaces 156 to complete the vendor item transaction on the entity website 124. The embedded widget 152 may connect to other services 144 and/or APIs 148 to complete the vendor item transaction. The embedded widget 152 may display one or more graphical interfaces 156 confirming the purchase of the vendor item (FIG. 4D). After completing the vendor item transaction, the consumer may continue with a transaction of an entity item, searching, or browsing the entity website 124.

It should be understood that the method 170 of FIG. 6 is an example and that other methods with similar steps are contemplated. In such other methods, additional steps may be included or steps may be omitted. Also, other methods may change the order of any of the steps. The method 170 may apply to other vendor items or vendor item transactions on the entity website 124 as described in this disclosure.

FIG. 7 is a flow chart illustrating a method 220 (or process 220) for completing item transactions or an item transaction journey on websites over the Internet according to one or more embodiments. Some or all the steps of method 220 may be performed using one or more computing devices and/or combination thereof described in this disclosure. In a variety of embodiments, some or all of the steps described below may be combined and/or divided into sub-steps as appropriate. Further, some or all of the steps of method 220 in FIG. 7 may be performed with method 170 in FIG. 6. In other words, some or all the steps of method 170 in FIG. 6 may be performed with method 220 in FIG. 7.

Referring to FIG. 7, at step 224, a consumer may navigate to an entity website 124 using the web browser 128 of the computing device 108. At step 228, in response to activation by the web browser 128, the embedded widget 152 may load or generate as part of the entity website 124. At step 232, as the entity website 124 loads, the embedded widget 152 may generate one or more graphical interfaces 156. At step 236, the consumer may interact with the embedded widget 152 or input information in the embedded widget 152 to complete a vendor item transaction on the entity website 124. In some embodiments, the one or more graphical interfaces 156 may include one or more data field entries 160 for receiving consumer input and inquiring about a vendor item. In some embodiments, the consumer input may include identifying information such as name and address, and the vendor item inquiry may be about an insurance product such as auto, home, or renter’s insurance policy. At step 240, after receiving the consumer input and the vendor item inquiry, the embedded widget 152 may establish a connection with the services 144 and/or the APIs 148 on the vendor system 112. For example, the embedded widget 152 may establish a connection with a service 144 executing on the vendor system 112.

At step 244, the vendor system 112 may execute the services 144 and/or APIs 148 based on the received consumer input and the vendor item inquiry. In some embodiments, the services 144 may execute a vendor item determination service that may determine whether the vendor item is available to the consumer based on the received consumer input and vendor item inquiry. At step 248, the vendor item determination service of the services 144 may determine the vendor item is available to the consumer (i.e., Yes at step 248). For example, at step 248, the vendor item determination service may determine the entity website 124 is approved to offer the vendor item based on a geolocation of the consumer and regulations associated with offering the vendor item in the consumer’s geolocation. If the entity system 104 or entity website 124 is approved to offer the vendor item (i.e., Yes at step 248), then the item transaction system 100 may continue to operate to complete a vendor item transaction. Based on the number of services 144 and/or APIs 148 that may be needed to complete a vendor item transaction, the item transaction system 100 may continue to operate and may repeat steps 232, 236, 240, 244, 248 as additional consumer input or interaction continues to be received (FIG. 7). The item transaction system 100 may continue to operate until the completion of the vendor item transaction or vendor item transaction journey on the entity website 124.

Alternatively, the item transaction system 100, the services 144 (e.g., vendor item determination service), and/or APIs 148 may determine an anomaly or deviation during the vendor item transaction. For example, an anomaly or deviation may occur when a vendor item determination service of the services 144 determines the vendor item cannot be offered for sale based on the entity website 124 and the geolocation of the consumer. For example, the entity website 124 may be unlicensed or not approved to offer the vendor item based on the geolocation of the consumer (e.g., region, state). In some embodiments, an anomaly or deviation may occur when the received consumer input indicates a region, a state, or a geolocation the entity website 124 is not approved or unlicensed to offer the vendor item.

If an anomaly or deviation occurs (i.e., No at step 248), at step 252, then the item transaction system 100 may establish a connection to the vendor system 112. For example, the embedded widget 152 may establish a connection to the vendor system 112. At step 256, the consumer may be redirected to a vendor website 168 hosted on the one or more vendor servers 132 (FIG. 5). The vendor website 168 may be different than the entity website 124. The consumer may be redirected to the vendor website 168 using an encrypted service or a secure transfer protocol such as HTTPS. At step 260, the consumer may complete the vendor item transaction on the vendor website 168. At step 260, the vendor website 168 may be in communication with the services 144 and/or the APIs 148 of the vendor system 112 to complete the vendor item transaction.

It should be understood that the method 220 of FIG. 7 is an example and that other methods with similar steps are contemplated. In such other methods, additional steps may be included or steps may be omitted. Also, other methods may change the order of any of the steps. For example, the item transaction system 100 may determine an anomaly at any step during method 220 of FIG. 7. Further, the determination of the anomaly (i.e., No at step 248) and the connection to the vendor website 168 (i.e., step 256) may occur at any step of in method 170 of FIG. 6 described above.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

For the purposes of describing and defining the present disclosure, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is noted that recitations herein of “at least one” component, element, etc., should not be used to create an inference that the alternative use of articles “a” or “an” should be limited to a single component, element, etc. It is further noted that recitations herein of “a”, “an”, “the”, “at least one”, and “one or more” are used interchangeably to indicate that at least one of the item is present and a plurality of such items may be present unless the context clearly indicates otherwise. It is also noted that recitations herein of a component of the present disclosure being “configured” or “programed” in a particular way, to embody a particular property, or to function in a particular manner, are structural recitations, as opposed to recitations of intended use.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

It is noted that one or more of the following claims utilized the term “wherein” as a transitional phrase. For the purposes of defining the present disclosure, it noted that his term is an open-ended transitional term that is used to introduce a recitation of a series of characteristics of the structure and should be interpreted in like manner as the more commonly used open-ended preamble term “comprising.”

### Representative Features

Representative features are set out in the following clauses, which stand alone or may be combined, in any combination, with one or more features disclosure in the text and/or drawings of the specification.

Clause 1. A method comprising: receiving, by a vendor system, a widget code portion; communicating the widget code portion to an entity system via a network connection between the entity system and the vendor system, the entity system including an entity website; embedding the widget code portion in the entity website; generating, based on the widget code portion and activation of a web browser, an embedded widget as part of the entity website, the embedded widget configured to: generate one or more graphical interfaces for receiving input data from a consumer, wherein the one or more graphical interfaces include one or more data field entries configured to receive information associated with the consumer and a vendor item; establish, based on the received input data, a connection with the vendor system, wherein the establishing of the connection with the vendor system includes connecting to a service executing on the vendor system; based on a determination, by the service, that the vendor item is available and the received input data, connect to an application programming interface executing on the vendor system; execute the application programming interface to determine vendor item information describing the vendor item; generate, based on the vendor item information, one or more additional graphical interfaces for displaying the vendor item information, wherein the one or more additional graphical interfaces include one or more controls selectable by the consumer to modify the vendor item information; and in response to a consumer selection by the one or more controls, generate an additional graphical interface of the one or more additional graphical interfaces for completing a transaction of the vendor item on the entity website without the consumer being redirected to a website different than the entity website.

Clause 2. The method of Clause 1, wherein the embedded widget is further configured to: based on a determination, by the service, that the vendor item is not available, establish a connection with a vendor website hosted on the vendor system, wherein the vendor website is different than the entity website; and redirect the consumer to the vendor website to complete the transaction of the vendor item.

Clause 3. The method of any of Clause 1 to Clause 2, wherein the vendor system includes one or more services and one or more application programming interfaces executing on the vendor system.

Clause 4. The method of any of Clause 1 to Clause 3, wherein the embedded widget is further configured to: based in response to the consumer selection by the one or more controls, connect to a payment processing service executing on the vendor system; and execute the payment processing service to complete a purchase of the vendor item on the entity website.

Clause 5. The method of any of Clause 1 to Clause 4, wherein the embedded widget refreshes a portion of the entity website in response to the consumer interacting with the embedded widget.

Clause 6. The method of any of Clause 1 to Clause 5, wherein remaining portions of the entity website remain static during the refreshing of the embedded widget.

Clause 7. The method of any of Clause 1 to Clause 6, wherein the embedded widget is further configured to: receive a plurality of consumer contents associated with the consumer, wherein the plurality of consumer contents is stored on the entity system; and dynamically populate the one or more data field entries of the one or more graphical interfaces with the plurality of consumer contents as the embedded widget is loaded as part of the entity website by the web browser.

Clause 8. A system comprising: a vendor system including one or move vendor servers, the vendor system configured to: generate a widget code portion; communicate the widget code portion to an entity system including one or more entity servers via a network connection between the vendor system and the entity system, the entity system including an entity website hosted on the one or more entity servers, wherein the widget code portion is embedded in the entity website; and a computing device associated with a consumer, the computing device including: at least one processor; a communication interface communicatively coupled to the at least one processor; a web browser; and memory storing computer-readable instructions that, when executed by the at least one processor, cause the computing device to: generate, by activation of the web browser, an embedded widget as part of the entity website, the embedded widget is configured to: generate one or more graphical interfaces for receiving input data from a consumer, wherein the one or more graphical interfaces include one or more data field entries configured to receive information associated with the consumer and a vendor item; establish, based on the received input data, a connection with the vendor system, wherein the establishing of the connection with the vendor system includes connecting to a service executing on the vendor system; based on a determination, by the service, that the vendor item is available and the received input data, connect to an application programming interface executing on the vendor system; execute the application programming interface to determine vendor item information describing the vendor item; generate, based on the vendor item information, one or more additional graphical interfaces for displaying the vendor item information, wherein the one or more additional graphical interfaces include one or more controls selectable by the consumer to modify the vendor item information; and in response to a consumer selection by the one or more controls, generate an additional graphical interface of the one or more additional graphical interfaces for completing a transaction of the vendor item on the entity website without the consumer being redirected to a website different than the entity website.

Clause 9. The system of Clause 8, wherein the embedded widget is further configured to: based on a determination, by the service, that the vendor item is not available, establish a connection with a vendor website hosted on the one or more vendor servers, wherein the vendor website is different than the entity website; and redirect the consumer to the vendor website to complete the transaction of the vendor item.

Clause 10. The system of any of Clause 8 to Clause 9, wherein the vendor system includes one or more services and one or more application programming interfaces executing on the one or more vendor servers.

Clause 11. The system of any of Clause 8 to Clause 10, wherein the embedded widget is further configured to: based in response to the consumer selection by the one or more controls, connect to a payment processing service executing on the vendor system; and execute the payment processing service to complete a purchase of the vendor item on the entity website.

Clause 12. The system of any of Clause 8 to Clause 11, wherein the embedded widget refreshes a portion of the entity website in response to the consumer interacting with the embedded widget.

Clause 13. The system of any of Clause 8 to Clause 12, wherein remaining portions of the entity website remain static during the refreshing of the embedded widget.

Clause 14. The system of any of Clause 8 to Clause 13, wherein the embedded widget is configured to: receive a plurality of consumer contents associated with the consumer, wherein the plurality of consumer contents is stored on the entity system; and dynamically populate the one or more data field entries of the one or more graphical interfaces with the plurality of consumer contents as the embedded widget is loaded as part of the entity website by the web browser.

Clause 15. A system comprising: a vendor system including one or move vendor servers, the vendor system configured to: generate a widget code portion; communicate the widget code portion to an entity system including one or more entity servers via a network connection between the vendor system and the entity system, the entity system including an entity website hosted on the one or more entity servers, wherein the widget code portion is embedded in the entity website; and a computing device associated with a consumer, the computing device including: at least one processor; a communication interface communicatively coupled to the at least one processor; a web browser; and memory storing computer-readable instructions that, when executed by the at least one processor, cause the computing device to: generate, by activation of the web browser, an embedded widget as part of the entity website, the embedded widget is configured to: generate one or more first graphical interfaces for receiving input data from a consumer, wherein the one or more first graphical interfaces include one or more data field entries configured to receive information associated with the consumer and a vendor item; establish, based on the received input data, a connection with the vendor system, wherein the establishing of the connection with the vendor system includes connecting to a service executing on the vendor system; based on a determination, by the service, that the vendor item is available and the received input data, connect to an application programming interface executing on the vendor system; execute the application programming interface to determine vendor item information describing the vendor item; generate, based on the vendor item information, one or more second graphical interfaces for displaying the vendor item information, wherein the one or more second graphical interfaces include one or more controls selectable by the consumer to modify the vendor item information; and in response to a consumer selection by the one or more controls, generate one or more third graphical interfaces for completing a transaction of the vendor item on the entity website without the consumer being redirected to a website different than the entity website.

Clause 16. The system of Clause 15, wherein the embedded widget is further configured to: based on a determination, by the service, that the vendor item is not available, establish a connection with a vendor website hosted on the one or more vendor servers, wherein the vendor website is different than the entity website; and redirect the consumer to the vendor website to complete the transaction of the vendor item.

Clause 17. The system of any of Clause 15 to Clause 16, wherein the embedded widget is further configured to: based in response to the consumer selection by the one or more controls, connect to a payment processing service executing on the vendor system; and execute the payment processing service to complete a purchase of the vendor item on the entity website.

Clause 18. The system of any of Clause 15 to Clause 17, wherein the embedded widget refreshes a portion of the entity website in response to the consumer interacting with the embedded widget.

Clause 19. The system of any of Clause 15 to Clause 18, wherein remaining portions of the entity website remain static during the refreshing of the embedded widget.

Clause 20. The system of any of Clause 15 to Clause 19, wherein the one or more controls include a button, a drop-down menu, a switch, or a toggle.

Aspects of the disclosure have been described in terms of illustrative embodiment thereof. Numerous other embodiments, modifications, and variations within the scope and spirit of the appended claims will occur to persons of ordinary skill in the art from a review of this disclosure. For example, one or more steps depicted in the illustrative figures may be performed in a different order other than the recited order, and one or more depicted steps may be optional in accordance with aspects of the disclosure.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method comprising:
receiving, by a vendor system, a widget code portion;
communicating the widget code portion to an entity system via a network connection between the entity system and the vendor system, the entity system including an entity website;
embedding the widget code portion in the entity website;
generating, based on the widget code portion and activation of a web browser, an embedded widget as part of the entity website, the embedded widget configured to:
generate one or more graphical interfaces for receiving input data from a consumer, wherein the one or more graphical interfaces include one or more data field entries configured to receive information associated with the consumer and a vendor item;
establish, based on the received input data, a connection with the vendor system, wherein the establishing of the connection with the vendor system includes connecting to a service executing on the vendor system;
based on a determination, by the service, that the vendor item is available and the received input data, connect to an application programming interface executing on the vendor system;
execute the application programming interface to determine vendor item information describing the vendor item;
generate, based on the vendor item information, one or more additional graphical interfaces for displaying the vendor item information, wherein the one or more additional graphical interfaces include one or more controls selectable by the consumer to modify the vendor item information; and
in response to a consumer selection by the one or more controls, generate an additional graphical interface of the one or more additional graphical interfaces for completing a transaction of the vendor item on the entity website without the consumer being redirected to a website different than the entity website.

2. The method of claim 1, wherein the embedded widget is further configured to:
based on a determination, by the service, that the vendor item is not available, establish a connection with a vendor website hosted on the vendor system, wherein the vendor website is different than the entity website; and
redirect the consumer to the vendor website to complete the transaction of the vendor item.

3. The method of claim 1, wherein the vendor system includes one or more services and one or more application programming interfaces executing on the vendor system.

4. The method of claim 1, wherein the embedded widget is further configured to:
based in response to the consumer selection by the one or more controls, connect to a payment processing service executing on the vendor system; and
execute the payment processing service to complete a purchase of the vendor item on the entity website.

5. The method of claim 1, wherein the embedded widget refreshes a portion of the entity website in response to the consumer interacting with the embedded widget.

6. The method of claim 5, wherein remaining portions of the entity website remain static during the refreshing of the embedded widget.

7. The method of claim 1, wherein the embedded widget is further configured to:
receive a plurality of consumer contents associated with the consumer, wherein the plurality of consumer contents is stored on the entity system; and
dynamically populate the one or more data field entries of the one or more graphical interfaces with the plurality of consumer contents as the embedded widget is loaded as part of the entity website by the web browser.

8. A system comprising:
a vendor system including one or move vendor servers, the vendor system configured to:
generate a widget code portion;
communicate the widget code portion to an entity system including one or more entity servers via a network connection between the vendor system and the entity system, the entity system including an entity website hosted on the one or more entity servers, wherein the widget code portion is embedded in the entity website; and
a computing device associated with a consumer, the computing device including:
at least one processor;
a communication interface communicatively coupled to the at least one processor;
a web browser; and
memory storing computer-readable instructions that, when executed by the at least one processor, cause the computing device to:
generate, by activation of the web browser, an embedded widget as part of the entity website, the embedded widget is configured to:
generate one or more graphical interfaces for receiving input data from a consumer, wherein the one or more graphical interfaces include one or more data field entries configured to receive information associated with the consumer and a vendor item;
establish, based on the received input data, a connection with the vendor system, wherein the establishing of the connection with the vendor system includes connecting to a service executing on the vendor system;
based on a determination, by the service, that the vendor item is available and the received input data, connect to an application programming interface executing on the vendor system;
execute the application programming interface to determine vendor item information describing the vendor item;
generate, based on the vendor item information, one or more additional graphical interfaces for displaying the vendor item information, wherein the one or more additional graphical interfaces include one or more controls selectable by the consumer to modify the vendor item information; and
in response to a consumer selection by the one or more controls, generate an additional graphical interface of the one or more additional graphical interfaces for completing a transaction of the vendor item on the entity website without the consumer being redirected to a website different than the entity website.

9. The system of claim 8, wherein the embedded widget is further configured to:
based on a determination, by the service, that the vendor item is not available, establish a connection with a vendor website hosted on the one or more vendor servers, wherein the vendor website is different than the entity website; and
redirect the consumer to the vendor website to complete the transaction of the vendor item.

10. The system of claim 8, wherein the vendor system includes one or more services and one or more application programming interfaces executing on the one or more vendor servers.

11. The system of claim 8, wherein the embedded widget is further configured to:
based in response to the consumer selection by the one or more controls, connect to a payment processing service executing on the vendor system; and
execute the payment processing service to complete a purchase of the vendor item on the entity website.

12. The system of claim 8, wherein the embedded widget refreshes a portion of the entity website in response to the consumer interacting with the embedded widget.

13. The system of claim 12, wherein remaining portions of the entity website remain static during the refreshing of the embedded widget.

14. The system of claim 8, wherein the embedded widget is configured to:
receive a plurality of consumer contents associated with the consumer, wherein the plurality of consumer contents is stored on the entity system; and
dynamically populate the one or more data field entries of the one or more graphical interfaces with the plurality of consumer contents as the embedded widget is loaded as part of the entity website by the web browser.

15. A system comprising:
a vendor system including one or move vendor servers, the vendor system configured to:
generate a widget code portion;
communicate the widget code portion to an entity system including one or more entity servers via a network connection between the vendor system and the entity system, the entity system including an entity website hosted on the one or more entity servers, wherein the widget code portion is embedded in the entity website; and
a computing device associated with a consumer, the computing device including:
at least one processor;
a communication interface communicatively coupled to the at least one processor;
a web browser; and
memory storing computer-readable instructions that, when executed by the at least one processor, cause the computing device to:
generate, by activation of the web browser, an embedded widget as part of the entity website, the embedded widget is configured to:
generate one or more first graphical interfaces for receiving input data from a consumer, wherein the one or more first graphical interfaces include one or more data field entries configured to receive information associated with the consumer and a vendor item;
establish, based on the received input data, a connection with the vendor system, wherein the establishing of the connection with the vendor system includes connecting to a service executing on the vendor system;
based on a determination, by the service, that the vendor item is available and the received input data, connect to an application programming interface executing on the vendor system;
execute the application programming interface to determine vendor item information describing the vendor item;
generate, based on the vendor item information, one or more second graphical interfaces for displaying the vendor item information, wherein the one or more second graphical interfaces include one or more controls selectable by the consumer to modify the vendor item information; and
in response to a consumer selection by the one or more controls, generate one or more third graphical interfaces for completing a transaction of the vendor item on the entity website without the consumer being redirected to a website different than the entity website.

16. The system of claim 15, wherein the embedded widget is further configured to:
based on a determination, by the service, that the vendor item is not available, establish a connection with a vendor website hosted on the one or more vendor servers, wherein the vendor website is different than the entity website; and
redirect the consumer to the vendor website to complete the transaction of the vendor item.

17. The system of claim 15, wherein the embedded widget is further configured to:
based in response to the consumer selection by the one or more controls, connect to a payment processing service executing on the vendor system; and
execute the payment processing service to complete a purchase of the vendor item on the entity website.

18. The system of claim 15, wherein the embedded widget refreshes a portion of the entity website in response to the consumer interacting with the embedded widget.

19. The system of claim 18, wherein remaining portions of the entity website remain static during the refreshing of the embedded widget.

20. The system of claim 15, wherein the one or more controls include a button, a drop-down menu, a switch, or a toggle.
